(19) United States
(12) Patent Application Publication
(10) Pub. No.: US 2021/0101297 A1
(43) Pub. Date: Apr. 8, 2021

(54) FOLDING KNIFE ASSEMBLY AND OPERATION SYSTEM

(71) Applicant: Christopher Gregory Iverson, Hockley, TX (US)

(72) Inventor: Christopher Gregory Iverson, Hockley, TX (US)

(21) Appl. No.: 16/591,556

(22) Filed: Oct. 2, 2019

(51) Int. Cl. B26B 5/00

(52) U.S. Cl. CPC B26B 5/00

(57) ABSTRACT

The present invention is a a folding knife apparatus which uses multiple components to create a system providing multiple benefits to the user. The knife can be quickly disassembled and assembled again with the use of tools. The pocket clip can be repositioned without changing mounting location and/or can be removed without tools. The blade lock which secures the blade in the open position can be adjusted for spring tension or removed and reinstalled without use of tools. The blade can be opened from a protrusion outside the handle with can pass by the blade stop without contact and be enclosed in handle when blade is in open position. The scales of the knife can be mounted on the frame to make up the handle by using screws which have a tool interface face inside the knife so that the outside screw head can be smooth or decorative.

### CROSS REFERENCE

The present application is related to provisional patent application number 62/739,971 filed on Oct. 2, 2018 by same inventor Christopher Gregory Iverson.

### APPENDIX

The present application comprises an appendix labeled as “Appendix-A” the entire contents of which are hereby incorporated by reference.

### FIELD OF THE INVENTION

The present invention relates to a handheld knife. More particularly, the invention relates to a handheld folding knife.

### BACKGROUND OF THE INVENTION

Folding knives are used for various means. Because of varying uses folding knives see, folding knives often require maintenance, replacement or configuration of certain elements to specific uses which require tools and/or disassembly of knife.

Common means of disassembly on folding knives require tools which could consist of wrenches, screwdrivers or punches in order to disassemble. Alternative means of quick disassembly either still require tools or reduce the strength of the knife.

Common means of attaching a pocket clip on folding knives require screws and are either restricted to one side of the knife or require a multiple mounting profiles to change pocket clip position on knife.

Folding knives often come with a spring action blade lock to reduce the chance of accidental closure during use. The blade lock can become worn or lose spring tension with continued use and require adjustment or replacement. Common means of attaching a blade lock to folding knives with a blade lock function require screws or special means to install or remove and do not additionally provide a means for user to adjust bring tension.

Common means of opening a folding knife blade by use of a protrusion on the blade which extends outside of the handle require that the protrusion on the blade does not rotate past the blade stop. When the protrusion location is put in a common place on back of handle behind the blade stop, this creates the need for a cavity in the handle behind the blade stop which reduces strength in a critical area of the knife. Alternative means of protrusion on blade to open with leave the protrusion in front of the blade stop but remain visible and exposed when the blade is in the open position.

Folding knife handles are often comprised of scales mounted onto frames to make up the handle assembly. Common means of affixing scales to frames is the use of screws which pass through a cavity in the scale and thread to the frame. This method is functional but leaves the maker restricted in aesthetic appearance on the outside surface as the tool interface used to affix the screw is showing and there are limited tool interface styles to choose from.

### BRIEF DESCRIPTION OF THE INVENTION

The folding knife assembly and operation system is a folding knife apparatus comprising of components which make the system. The system provides for quick disassembly for access to common wear components. System also provides for repositioning of pocket clip without changing mounting location and adjustment and removal of blade lock without tools. The system provides for opening the blade with a protrusion on blade which can rotate past the blade stop so that protrusion on blade is hidden from view when blade is in open position. The system provides for mounting the scales onto the frames using screws which have the tool interface facing inside the knife so that the outward facing screw head can be smooth or ornamental.

### BRIEF DESCRIPTION OF THE DRAWINGS

A clear understanding of the key features of the invention summarized above may be had by reference to the appended drawings, which illustrate the apparatus components which comprise the system of the invention, although it will be understood that such drawings depict preferred embodiments of the invention and, therefore, are not to be considered as limiting its scope with regard to other embodiments which the invention is capable of contemplating. Accordingly:

FIG. 1 is an illustration of the right side of the knife in assembled and opened and locked state.

FIG. 2 is an illustration of the left side of the knife in assembled and opened and locked state.

FIG. 3 is a bottom view, exploded diagram showing all components of knife

FIG. 4 is an isometric view of inside of left frame (2) in its most basic assemble state with set screw 8 installed.

FIG. 5 is an isometric view of inside of right frame (1) in its most basic assemble state with pivot pin 3, blade stop pin 4 and set screw 8 installed.

FIG. 6 is an isometric view showing left frame 2, left scale 16, scale screws 9 and lanyard screw 10 prior to being mounted together. View of outward face of screw head, smaller diameter threaded screw shaft, shoulder cavity in left scale 16 and threaded holes in left frame 2 are shown.

FIG. 7 is an isometric view showing right frame 1, right scale 15, scale screws 9 and lanyard screw 10 prior to being mounted together. View of outward face of screw head, smaller diameter threaded screw shaft, shoulder cavity in right scale 15 and threaded holes in right frame 1.

FIG. 8 shows scale screw 9 from multiple angles. A top view showing outward face of head, a side view showing shoulder profile and a bottom view showing threaded shaft end profiled for tool interface. FIG. 8K is a detail view showing preferred embodiment shown as a hexagon shaped profile to accept what is commonly referred to as an allen wrench.

FIG. 9 shows lanyard screw 10 from multiple angles. A top view showing outward face of head, a side view showing shoulder profile and a bottom view showing threaded shaft end profiled for tool interface as well as an isometric view showing additional angle of tool interface.

FIG. 10 is referential drawing for a sectional illustration detailing the mating profile of the scale screws 9 to scales 15 and 16 as well as frames 1 and 2. L-L shows the sectional view. M shows a detailed view. All scale screws 9 and lanyard screws 10 have the same mating profile. The lanyard screws are not shown in sectional view.

FIG. 11 shows blade lock 5 specifically pointing to mounting slot. Detent ball 7 rigidly attached to blade lock 5 and blade lock spring 6 in a position it would normally be at when both blade lock spring 6 and blade lock 5 are installed on frame 1.

FIG. 12 is an illustration showing frame 1 with annotation 1 pointing specifically to the mounting element for blade lock 5. Blade lock spring 6 is shown inserted into cavity of frame 1.

FIG. 13 is an illustration showing blade lock 5 halfway slid onto frame 1

FIG. 14 is an illustration showing blade lock 5 fully installed on frame 1 protruding under spring tension to lock blade 17 in the open position.

FIG. 15 is an illustration showing pocket clip 13 separated from frame 1. Annotation N identifies reference area for detail view N showing the single mounting location on frame 1 profiled to accept the mounting profile of pocket clip 13.

FIG. 16 is a front view illustration showing pocket clip 13 rotated to right side of knife.

FIG. 17 is a front view illustration showing pocket clip 13 rotated to left side of knife.

FIG. 18 is an isometric illustration showing pocket clip 13 located within mounting cavity of frame 1 rotated to right side of knife.

FIG. 19 is an isometric illustration showing pocket clip 13 located within mounting cavity of frame 1 rotated to right side of knife and frame 2 installed to lock pocket 13 into position.

FIG. 20 is an isometric illustration of frame 2 with annotation 2 pointing specifically to slot element.

FIG. 21 is an isometric illustration of frame 1 with annotation 1 pointing specifically to slot element and pivot pin 3 installed.

FIG. 22 is a reference illustration which shows the location on knife which FIG. 22 A-A is sectioned from as well as showing the location on knife which detail view B is taken from.

FIG. 22B is a detail view showing how slot elements on frame 1 and frame 2 mate together.

FIG. 22A-A is a section view showing frame 1 threaded to accept pivot pin 3, blade 17 which can rotate on pivot pin 3 and frame 2 which is has a cavity profiled to accept the locking profile on pivot pin 3.

FIG. 23 is an isometric illustration of the components relating to the quick assembly and disassembly feature. Annotation 2 identifying left frame 2 points specifically to the cavity containing a twist to lock profile to mate with pivot pin 3. U annotates a detail view of the cavity cut into the slot on frame 2 which provides a locking point for takedown pin 11.

FIG. 24 is an isometric illustration of frame 2 at start of assembly where frame 3 has slid onto pivot pin 3 and is ready to rotate. Q annotates a detailed view of take down pin area where takedown pin 11 is rotated in the open position which allows frame 2 to pass through the slot.

FIG. 25 is an isometric illustration of frame 2 halfway rotated to assembled position. The locking profile between frame 2 and pivot pin is already engaging but slot elements on frames 1 and 2 have not engaged yet.

FIG. 26 is an illustration showing knife having completed assembly.

FIG. 27 is an isometric reference illustration with left scale removed for detail view R. R is a detail view showing the slots in fames 1 and 2 mated and takedown pin rotated to the locked position.

FIG. 28 is a reference illustration with left frame for detail view T. T is a detail view showing the slot in fames 1 blocked by takedown pin 11 rotated in the locked position.

FIG. 29 is a reference illustration with blade 17 in the closed position within handle and annotation 17 pointing specifically to the profiled protrusion which extends outside of frame 1. C annotates a detailed view showing this protrusion.

FIG. 30 is a reference illustration with left frame removed to show internal workings and blade 17 during opening where profiled protrusion is freely rotating past blade stop pin 4 without contact. D annotates a detailed view of this.

FIG. 31 is a reference illustration with left frame removed to show internal workings and blade 17 in open and locked position where profiled protrusion completely passed blade stop pin 4 as is enclosed within the knife and blade is at rest against blade stop pin. E annotates a detailed view showing blade 17 resting against blade stop pin 4. Detailed view E also shows material on frame 1 behind the direction of opening rotation which further supports the blade stop pin 4.

FIG. 32 is a reference components list for the preferred embodiment detailing item number, quantity used in apparatus and description.

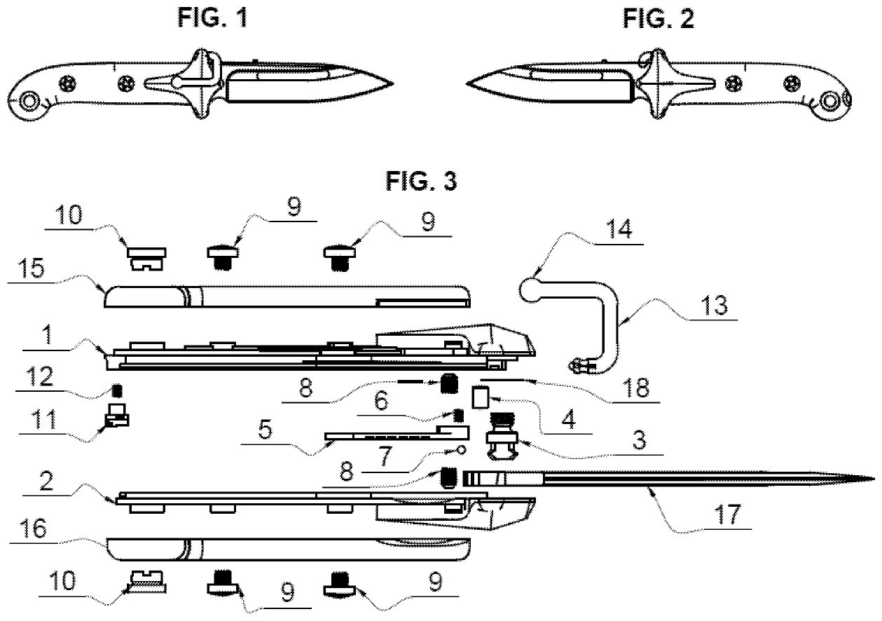

### DETAILED DESCRIPTION OF THE INVENTION

The terminology used herein is for the purpose of describing particular embodiments only and is not intended to be limiting of the invention. The term “and/or” includes any and all combination of one or more of the associated listed items. Singular forms “a,” “an,” “the,” are intended to include the plural forms as well as the singular forms unless the context clearly indicates otherwise. It is further understood that terms “compromises” and/or “compromising” specify the presence of stated techniques, steps, features, operations, elements, components and/or assemblies but do not preclude the presence or addition of other techniques, steps features, operations, elements, components and/or assemblies thereof.

Unless otherwise defined, all terms used herein have the same meaning as defined by commonly used dictionaries with their meaning consistent with their meaning in the context of the relevant art to which this invention belongs and will not be interpreted in an idealized, restrictive or overly formal sense unless expressly so defined herein.

In describing the invention, it is understood that a number of techniques, steps, operations are disclosed. Each of these have individual benefit and each can also be used in conjunction with one or more other techniques, steps or operations disclosed. Accordingly, for the sake of clarity, this description will refrain from repeating every possible combination and provide notation on techniques, steps features, operations which are dependent on one another.

The present disclosure is to be considered as an exemplification of the invention and is not intended to limit the invention to specific embodiments illustrated by the figures or the description contained herein.

The present invention will now be described by referencing the appended figures representing preferred embodiments.

Elements making up the frames of the knife which are maker installed and are not meant to be a part of standard user assembly and disassembly are first assembled. Pivot pin 3 is inserted onto frame 1 and retained via the threads. Blade stop pin 4 is inserted into a matching size hole in frame 1 and is held securely by means of press-fit. Threaded set screws 8 are inserted in threaded holes in frames 1 and 2 and tightened.

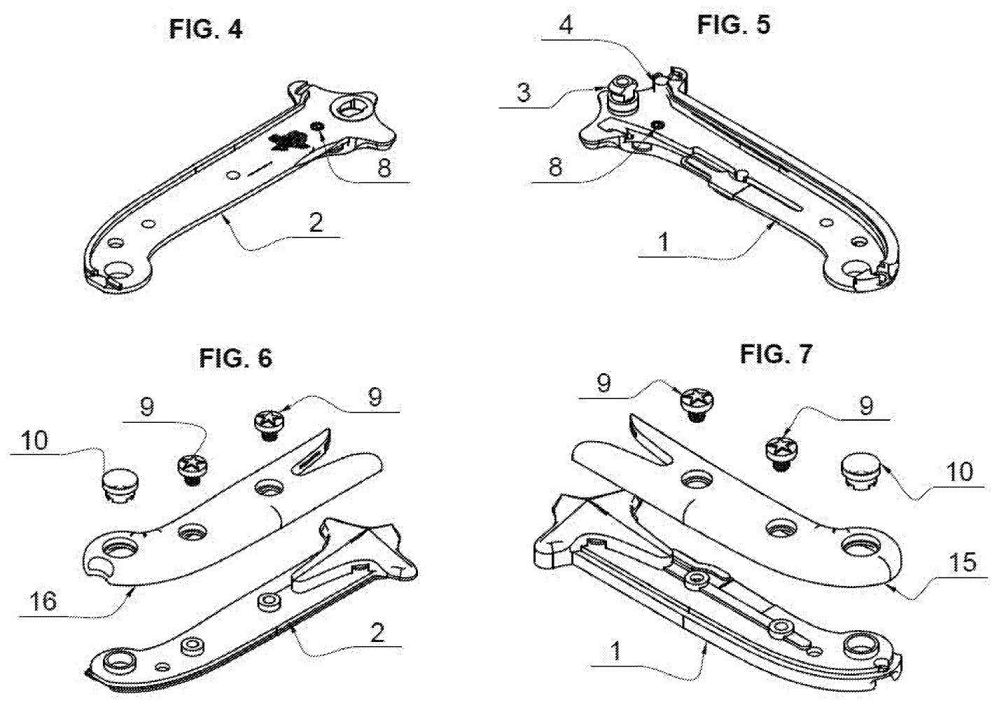

This completes the assembly of components which are not meant to be user assembled. FIG. 4 shows left frame in this state and FIG. 5 shows right frame in this state.

Elements making up the knife which are occasionally removed, replaced or repositioned by user are assembled next.

The scale screws 9 and lanyard screws 10 are used to affix the right scale 15 to right frame 1 and left scale 16 to left frame 2. In preferred embodiments a combination of scale screws 9 and lanyard screws 10 is used to affix the scales to the frames but lanyard screws are not required in alternate embodiments. In preferred embodiments scales screws 9 are identical to each other but this is not required. In preferred embodiments lanyard screws are identical to each other but this is also not required.

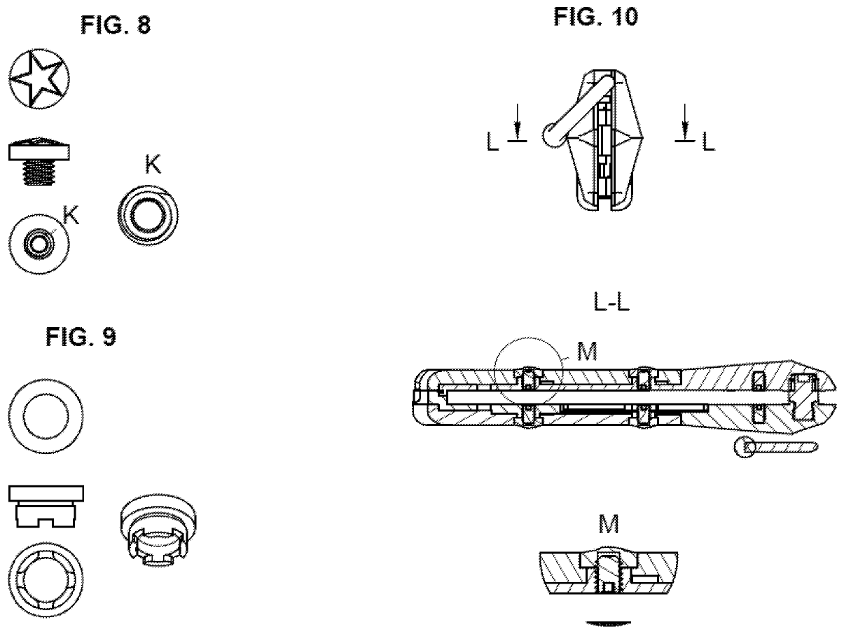

The scale screws 9 and lanyard screws 10 comprise of a head which is larger than the shaft diameter to create a shoulder to fit within a shouldered cavity contained on scales 15 and 16. The outward facing surfaces of both scale screws 9 and lanyard screws 10 can have a variety of designs including but not limited to flat, convex, concave and hollow as well as any ornamental stylings of those designs. The defining characteristic of the outside surface of the head is it must not have a tool interface for which to tighten the screw. A threaded shaft extends from the head which is used to affix the screw to frames 1 and 2. The shaft end opposite of the head has a tool interface so that the screw can be rotated and tightened to frames. As visual reference for the above can be had by viewing FIG. 8 for scale screws and FIG. 9 for lanyard screws.

FIG. 6 AND FIG. 7 shows frames 1 and 2, scales 15 and 16 and scale screws 9 and lanyard screws 10 prior to mounting. Steps for mounting of scales onto frames are identical from right and left sides so only right side will be discussed for brevity. Right scale 15 is placed onto right frame 1 where the screw cavities on right scale 15 match up with screw cavities on right frame 1. From the outward facing direction scale screws 9 are inserted through the cavity of right scale 15 to contact the threaded cavity of frame 1. From the inward direction a tool is placed into the inward facing tool interface on the threaded shaft of the screw. The tool and screw resultingly are rotated to engage the threads and tighten the screw into assembled condition. Once the screw is in assembled condition the shoulder of the screw head rests against the shouldered cavity in scale 15 which results in affixing the scale 15 to frame 1. The steps for mounting the lanyard screws 10 are identical to the scale screws 9 with the only difference being the diameter of head or shaft and type of tool interface at end of shaft which are not required to be the same as the scale screws 9.

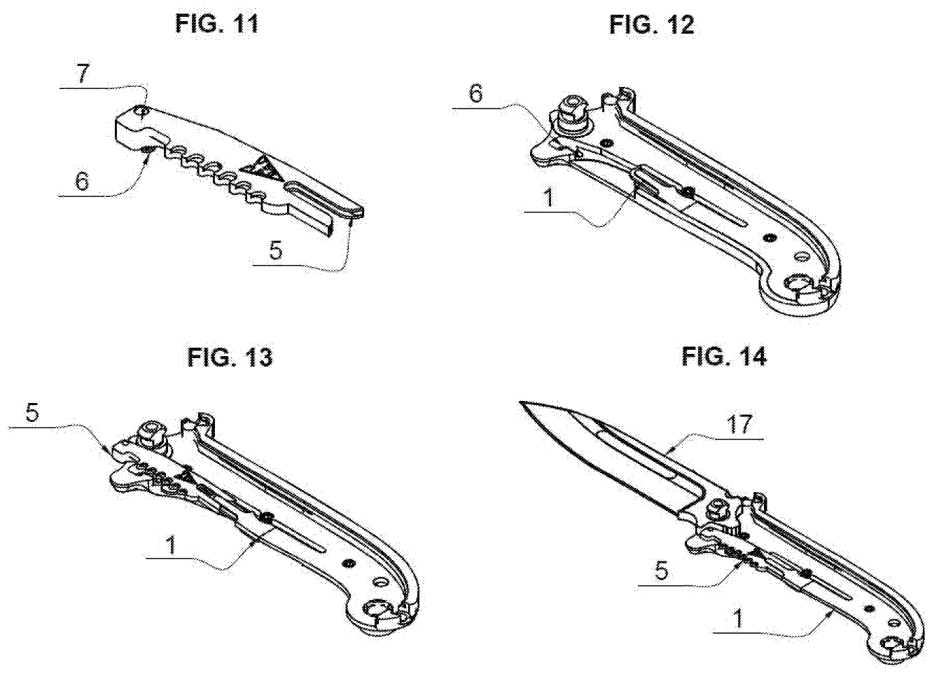

The blade lock can be removed and reinstalled on frame 1 without the use of tooling and comprises of the blade lock body and a detent ball 7 rigidly mounted to it. In preferred embodiments access to blade lock 5 is accomplished by use of the quick assembly and disassembly steps listed in [0059] and [0061] but the mounting and adjusting features of blade lock 5 to frame 1 is independent of this. A mounting slot element on blade lock 5 allows for blade lock 5 to slide onto frame 1. This is shown in FIG. 11 where annotation 5 points directly to the mounting slot element. Frame 1 which has a mounting element profiled to fit slot on blade lock 5 which is shown in FIG. 12 where annotation 1 points directly to mounting slot element. On preferred embodiments the mounting slot element is on the blade lock 5 with matching mounting element on frame. FIG. 11 shows the detail of mounting slot element on blade lock as well as detent ball 7 rigidly mounted in blade lock 5 and blade lock spring 6 located in a position behind blade lock. With alternate embodiment not shown the mounting slot element can be on frame 1 with a matching mounting element on blade lock 5. A bend on frame 1 mounting element provides the majority of the spring tension required for blade lock 5 to engage a locking profile on blade 17 when the blade is in fully opened position. The bend on frame 1 mounting element is shown in FIG. 13 with annotation 1 point specifically to bend area. The bend can be located in any area behind the blade lock mounting element. Prior to assembling blade lock 5 onto frame 1, blade lock spring 6 is installed in a cavity on frame 1 to provide user adjustable additional spring tension which can be further adjusted by using springs with different spring force. FIG. 12 annotation 6 shows the location of the spring once installed in the cavity of frame 1. After blade lock spring is installed in cavity on frame 1 the blade lock 5 can be slid onto frame 1 to assembled position. This is accomplished by hand and without the use of tools. FIG. 13 shows blade lock 5 halfway installed on frame 1 mounting element. Blade lock 5 is retained in place by the static friction along the length of the slot mount element provided by the blade lock spring 6 tension which is contained between the blade lock 5 and frame 1. In the open and locked position blade lock 5 engages a profile formed on blade 5 under the spring tension created by both the bend on frame 1 and blade lock spring 6. FIG. 14 shows blade 17 in the open and locked position with blade lock 5 engaged against the locking profile of blade 17. To close the blade 17 the blade lock 5 is pushed in the outward direction until the blade lock 5 is clear of the blade 17. Blade 17 rotates on pivot pin 3 towards a closed position. As the blade is rotated it is no longer necessary to push on the blade lock 5 and blade lock 5 is allowed to come to rest against the side of blade 17 under spring tension. Once the blade reaches the fully closed position the detent ball 7 which is rigidly mounted to blade lock 5 rests in a cavity on blade 17 so that blade 17 is held in closed position under static force. The static force is sufficient to keep the blade 17 from freely rotating out of closed position until action is taken to open the blade 17.

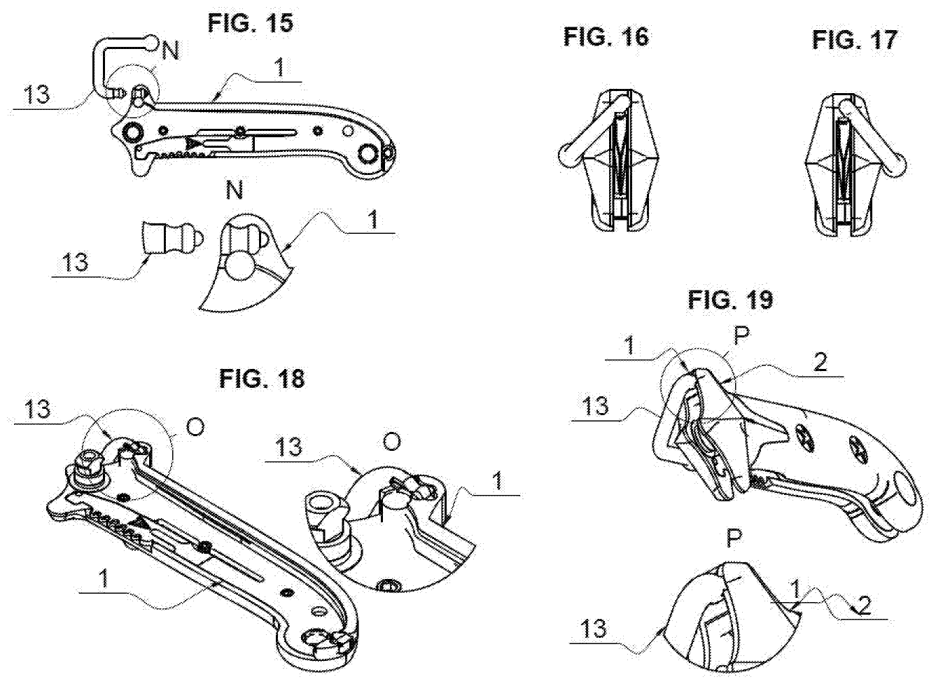

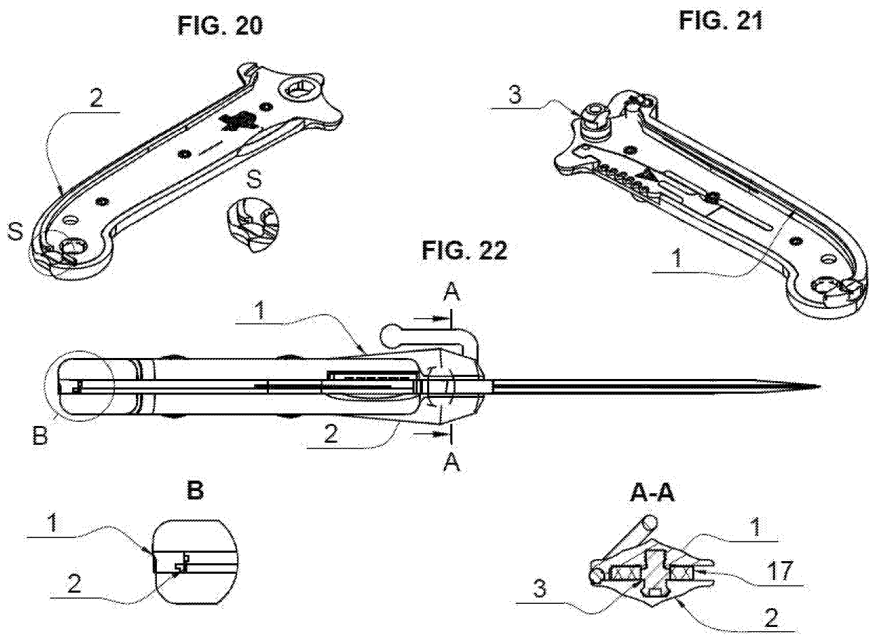

Removal or repositioning of pocket clip 13 is accomplished with the knife in a partially disassembled state. In preferred embodiments this is accomplished by use of the quick assembly and disassembly steps listed in [0059] but the pocket clip mounting and positioning feature is independent of this. The only requirement for the pocket clip to be removed or repositioned without tooling is that the handle not be fully assembled so that access to the cavity in frame 1 which is part of the handle is unimpeded. A single cavity in frame 1 is profiled to allow pocket clip 13 to rotate along its axis and grooved or slotted to prevent it from sliding out of the cavity along its length which is visually represented in FIG. 15 This provides a single mounting location for the pocket clip where the pocket clip is rotated along its axis to provide for either a right-hand or left-hand carrying position. Pocket clip 13 can rotate within the cavity of frame 1 until frame 2 is installed. Frame 2 is installed to complete assembly of handle. FIG. 16 shows pocket clip 13 rotated to right side of knife and FIG. 17 shows pocket clip 13 rotated to left side of knife. Frame 2 provides a surface which both prevents the pocket clip 13 from being removed from cavity of frame 1 and prevents rotation of pocket clip 13 within cavity of frame 1 as is shown in FIG. 19.

This completes the assembly of components which are occasionally removed, replaced or repositioned by user. FIG. 4 AND FIG. 5 show knife assembled to this state.

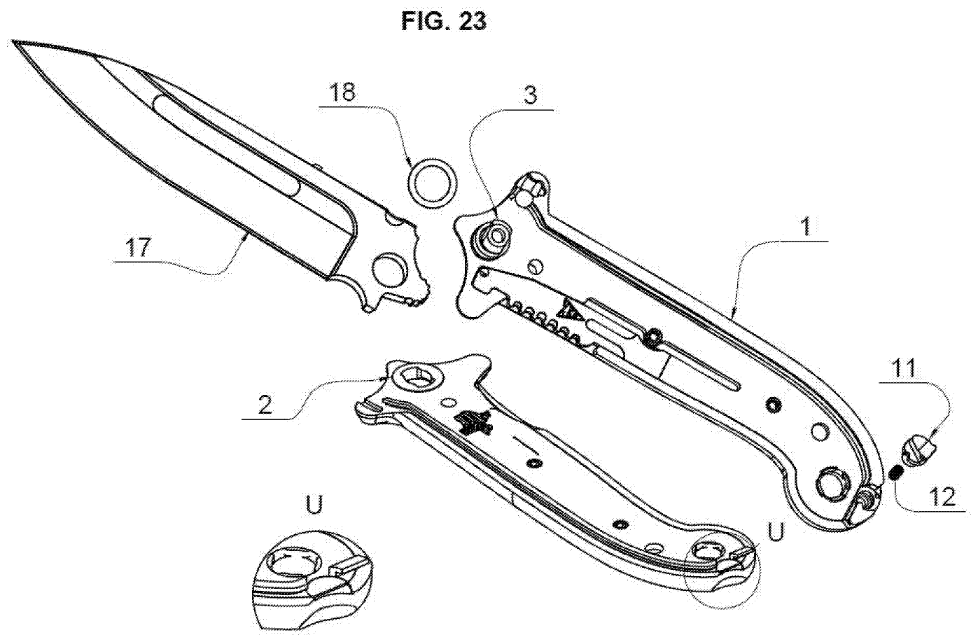

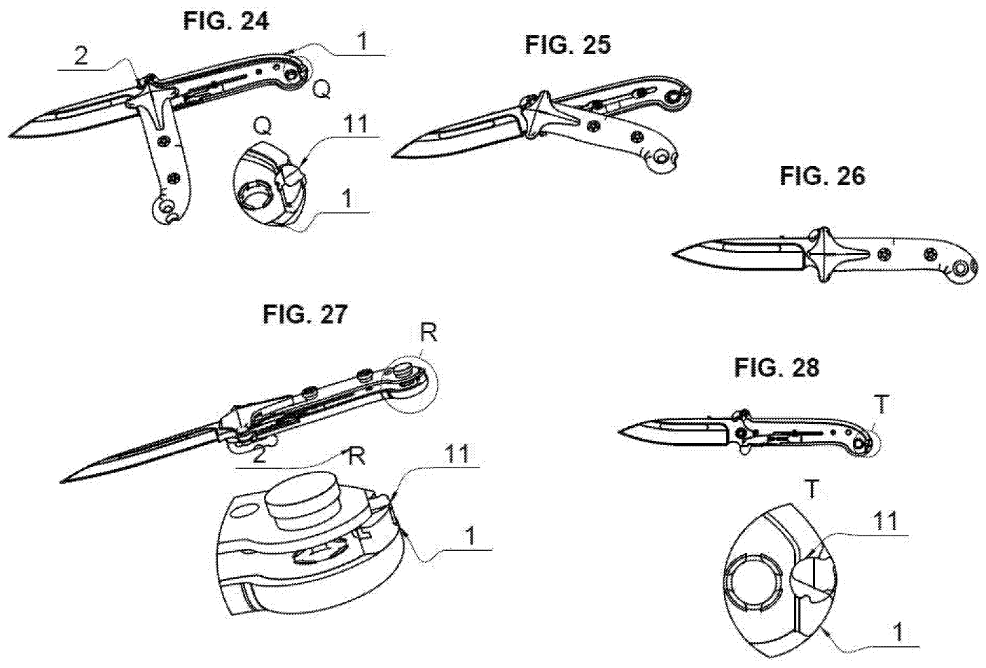

Elements making up the knife which are part of the quick assembly and disassembly feature of the knife are now assembled without use of any tooling. The annotated components in FIG. 23 are a visual illustration of the components involved. Takedown pin spring 12 is inserted in cavity of takedown pin 11 then takedown pin 11 is inserted into a cavity of frame 1 and rotated to the open position which retains it to frame 1 under spring tension. FIG. 24 detail view Q is a visual representation of takedown pin installed and rotated to open position allowing for clearance of the slots. Pivot spacer 18 is slid onto pivot pin 3 until it contacts frame 1. Blade 17 is slid onto pivot pin 3 with blade in the open position until it contacts pivot spacer 18. Blade lock 5 is under spring tension which pushes outwards from frame 1 to engage a locking profile on blade 5 so that blade 5 is in the open and locked position and FIG. 14 can be referred to as a visual representation of this position. Frame 2 is held in a position which lines up the slot on the cavity of frame 2 with the slot on pivot pin 3. Frame 2 is slid onto pivot pin 3 until it reaches a shoulder on pivot pin 3 as a stopping point and FIG. 24 is a visual representation of assembly to this point. Frame 2 is then rotated to engage the locking shoulder of pivot pin 3. As frame 2 is rotated it engages slot/s on frame 1 along the length by means on matching slot/s profile along length of frame 2. Frame 2 is rotated until it reaches a stopping point created by the contact of the shoulders of the slots of both frames and this is visually represented in FIG. 27 which has the left scale 16 hidden for ease of viewing. Once stopping point has been reached takedown pin 11 is rotated into the closed position where takedown pin 11 rests against a shoulder in the cavity of frame 2. Cavity of frame 2 is visually represented by FIG. 23 detail view U. This prevents both frames from rotating away from each other as the cavities on both frames which allow for rotation of the frames onto and off of each other are now blocked. FIG. 28 detail view T shows the takedown pin rotated to the closed position with left frame hidden to illustrate how the slots are blocked in closed position. IN preferred embodiments the pin rotates to block the slots but alternatively a sliding pin or lever can be used instead. In preferred embodiments slots in frames run the entire length of the frames but this is not required. Shorter slots can alternatively be placed in spaced locations along the length of the frames.

This completes the assembly of components which are part of the knife quick assembly and disassembly feature.

Quick disassembly of knife is accomplished by completing the previous steps listed in [0059] in the reverse order.

Complete disassembly of knife is accomplished by completing the steps listed in [0050]-[0059] in the reverse order.

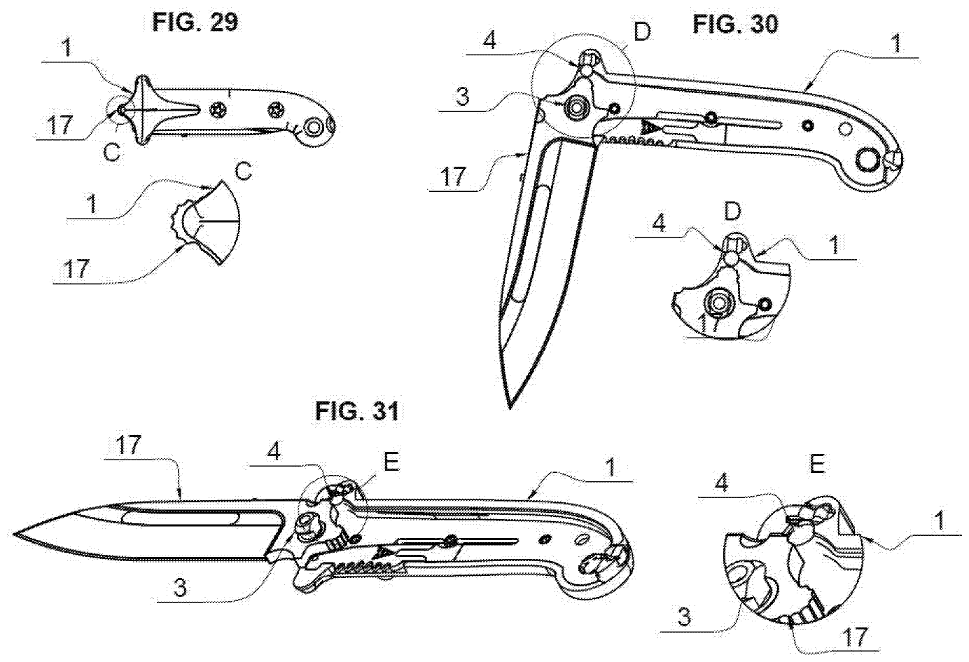

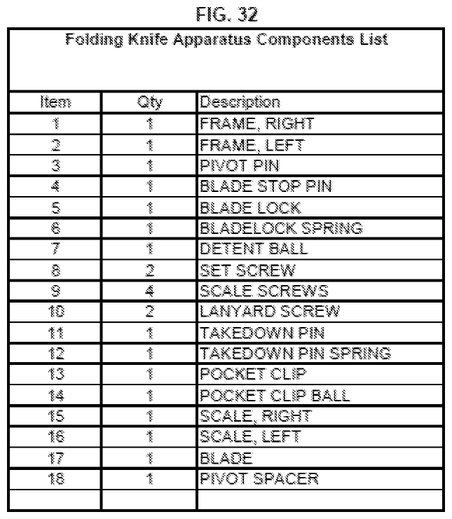

The blade 17 comprises of elements to allow blade to rotate from the open and closed positions, an operating profile to assist opening the blade, a locking profile to assist with keeping the blade in a locked position when open as well as a cavity formed to assist with keeping blade in closed position. A hole in blade 17 is provided to allow for blade to mount on pivot pin 3 and rotate with minimal force required. The operating profile on blade 17 protrudes from the handle when blade 17 is in closed position which is visually represented in FIG. 29. The operating profile is rotated by the user to open blade to the fully extended and locked position. As blade 17 rotates the operating profile passes the blade stop pin 4 and is fully contained within the handle when the blade is in the fully opened and locked position. The need to remove material from behind blade stop pin 4 is eliminated because the operating profile on blade 17 can rotate freely past blade stop pin 3 which is visually represented in FIG. 30. This provides maximum strength to support the blade stop pin 4 at a location which has the potential to see maximum force from blade 17 pushing against blade stop pin 4 during use as can be seen visually in Detail E of FIG. 31. The operating profile on blade 17 also provides lateral support to blade 17 when blade 17 is in the open position by providing a point of support within the frame opposite the extended tip of the blade which is farther away from the center point of rotation.

What I claim is:

1. A folding knife which has shoulder head screws which affix the handles to the frame where the outward face of head does not have a tool interface comprising of: A shoulder screw with threaded shaft of smaller diameter than head where the outward facing surface of the head cannot include a tool interface intended to tighten the screw and has a tool interface on end of shaft opposite to the outward facing head for tightening screw, a scale which has a shouldered cavity comprising of both a larger diameter hole to fit the head of the screw and a smaller diameter hole to fit the shaft of the screw, a frame which has a threaded hole which fits the shaft of the screw to mount screw and secure both screw and scale to frame.

2. A folding knife which has a blade lock for locking the blade in the open position which has adjustable tension and can be removed and adjusted without use of tools comprising of: a blade lock with a mounting profile which allows it to slide onto knife handle to assembled position which can lock the blade into open position and a face profiled to lock against a blade; a handle which has a frame profiled to allow the blade lock to slide into assembled position onto the frame which is also bent inward towards blade to provide spring tension for blade lock and has a cavity behind the blade lock, a spring which can be installed in the cavity on the frame to add or adjust the spring tension of the blade lock against the blade, a blade which can be locked into position by the blade lock

3. A folding knife which has a pocket clip which can be positioned to right or left side of the knife handle without changing the mounting location on the knife comprising of: a pocket clip with mounting portion profiled to fit into a cavity on the knife handle which is locked into position when knife is fully assembled and can be removed without tools when the knife is not fully assembled, a handle which has cavity to fit the pocket clip which locks the pocket clip into position when handle is fully assembled which allows removal of pocket clip from cavity without tools when knife is not fully assembled.

4. A folding knife which can assemble and disassemble quickly without additional tools required comprising of: a pivot pin profiled on one side to mount rigidly on one frame and profiled on other side with twist lock to mount to second frame; a frame profiled for mounting of pivot pin rigidly which is also slotted along length for mounting of second frame and has a cavity to contain a locking pin or lever to prevent frames from rotating away from each other when placed in locked postion, a second frame which has a cavity to contain the twist lock profile of the pivot pin and is slotted along the length of the handle to mount with the first frame and has a cavity to contain a locking pin or lever.

5. A folding knife which has a portion of the blade which protrudes from the handle that can be used to open the blade which can rotate past the blade stop without contact comprising of: a blade with protrusion from the handle in the closed position which can be used to open the blade and rotates past blade stop without contact while opening as well has a hole in the blade allowing blade to rotate on a pivot pin; a handle which has cavities to contain the blade, the blade stop and the pivot pin; a blade stop which fits into a cavity in the handle and provides a stopping point for the blade in the fully opened position; a pivot pin mounted on the cavity in the handle which provides a rotation point for the blade.
